(19) United States
(12) Patent Application Publication
(10) Pub. No.: US 2005/0191058 A1
(43) Pub. Date: Sep. 1, 2005

(54) High speed active optical system to change an image wavelength

(76) Inventor: Jeffrey H. Hunt, Thousand Oaks, CA (US)

Correspondence Address: STRADLING YOCCA CARLSON & RAUTH;SUITE 1600, 660 NEWPORT CENTER DRIVE, P.O. BOX 7680, NEWPORT BEACH, CA, 92660, US

(21) Appl. No.: 10/788,778

(22) Filed: Feb. 26, 2004

(51) Int. Cl. H04B 10/00

(52) U.S. Cl. 398/140

(57) ABSTRACT

The present application is directed to high speed optical system. In one embodiment, the optical system includes a photodiode which is sensitive to a wavelength of light, a first source of photons at a first wavelength to which the photodiode is sensitive incident on the photodiode, a second source of photons at a second wavelength to which the photodiode is insensitive incident on the photodiode, an electric field across the photodiode in excess of the breakdown voltage thereof and configured to result in an avalanching of electrons in the photodiode when the photons from the first source strike the photodiode, and a capture device in optical communication with and configured to capture light reflected from the photodiode. The avalanche of electrons within the photodiode results in a photorefractive response which changes the index of refraction in the photodiode. Light reflected from the photodiode is modulated by the photorefractive response and is subsequently captured by the capture device.

### BACKGROUND

Frequently, in opto-electronic applications, optical components within a system operate most efficiently within predetermined wavelength ranges. The operational wavelength range of one component or subsystem may differ from adjoining components or subsystems. As a result, it is often necessary to convert the wavelength of an optical signal to another wavelength one or more times as the signal traverses through a system.

Often, wavelength conversion is accomplished by an optical-to-electrical conversion process. Typically, an input optical signal of a first wavelength is received by an optical receiver such as a photodiode. The optical receiver converts the input optical signal to an electrical signal which is coupled to an electrical circuit. The electrical signal is used to drive a photon source configured to output an optical signal at the desired wavelength. Exemplary photon sources include light emitting diodes, laser diodes, solid state lasers, dye lasers, and like devices. In addition to the photon source, the electrical circuit may include a number of addition electronic components such as microprocessors, device drivers, power sources, and the like.

While optical-to-electrical conversion systems have proven useful in the past, a number of shortcomings have been identified. For example, the response times of these systems may be unacceptably slow for some applications. Response time issues may not prove problematic when data rates are low. However, as data rates increase the time required to covert the image from an optical signal of a first wavelength to an electrical signal then back to another optical signal of a second wavelength grows. For example, response rates ranging from hundreds of megahertz to several gigahertz are not uncommon. As such, the throughput of the system is proportionately effected. Furthermore, discontinuities or noise may be introduced into the signal during the conversion process.

Thus, in light of the foregoing, there is an ongoing need for a system capable of rapidly converting an optical signal of a first wavelength to a second wavelength.

### BRIEF SUMMARY

The various embodiments of the optical system disclosed herein enable a user to easily convert an image received at a first wavelength to a second wavelength. Furthermore, the various systems disclosed herein permit optical-to-optical conversion of signals, thereby reproducing the input signal at a user-determined wavelength.

In one embodiment, the present application is directed to a high speed optical system and discloses a photodiode which is sensitive to a wavelength of light, a first source of photons at a first wavelength to which the photodiode is sensitive incident on the photodiode, a second source of photons at a second wavelength to which the photodiode is insensitive incident on the photodiode, an electric field across the photodiode in excess of the breakdown voltage thereof and configured to result in an avalanching of electrons in the photodiode when photons from the first source strike the photodiode, and a capture device in optical communication with and configured to capture light reflected from the photodiode. The avalanche of electrons within the photodiode results in a photorefractive response which changes the index of refraction in the photodiode. Light reflected from the photodiode is modulated by the photorefractive response and is subsequently captured by the capture device.

In an another embodiment, the present application is directed to a high speed optical system and discloses an InGaAsP photodiode which is sensitive to a wavelength of light, a first source of photons configured to transmit an optical signal at a first wavelength to which the photodiode is sensitive incident to the photodiode, a second source of photons at a second wavelength to which the photodiode is insensitive incident on the photodiode, an electric field across the photodiode in excess of the breakdown voltage thereof and configured to result in an avalanching of electrons in the photodiode when photons from the first source strike the photodiode, the avalanching electrons resulting in a photorefractive response which changes the index of refraction in the photodiode, and a capture device in optical communication with and configured to capture light reflected from the photodiode.

In still another embodiment, the present application is directed to a high speed optical system and discloses an InGaAsP photodiode having a bandgap, the photodiode configured to operate in Geiger mode, a first photon source configured to emit an optical signal of a first wavelength, the first wavelength less than the bandgap of the photodiode, a second photon source configured to emit light of a second wavelength, the second wavelength greater than the bandgap of the photodiode, a beam combiner positioned within an optical path and configured to combine the first and second wavelengths, an electric field applied across the photodiode greater than a breakdown voltage thereof, the electric field configured to result in avalanching of electrons in the photodiode when photons from a first photodiode are incident thereon, the avalanche of electrons resulting in a photorefractive response within the photodiode, and a capture device in optical communication with and configured to capture modulated light reflected from the photodiode.

The present application further discloses various optical-to-optical conversion methods for converting an optical signal of a first wavelength to a second wavelength. One method disclosed in the present application includes baising a photodiode to operate in Geiger mode, irradiating a photodiode with a first wavelength of light to which the photodiode is sensitive, the first wavelength of light transmitting an optical signal, irradiating the photodiode with a second wavelength of light to which the photodiode is insensitive, modulating light reflected from a surface of the photodiode with a photorefractive reaction within the photodiode, and capturing the modulated reflected light.

In an alternate embodiment, the present application discloses configuring a photodiode to operate in Geiger mode, irradiating a photodiode with a first wavelength of light transmitting an optical signal, initiating a photorefractive reaction within the photodiode with the first wavelength of light, irradiating the photodiode with a second wavelength of light to which the photodiode is insensitive, modulating light reflected from a surface of the photodiode with the photorefractive reaction within the photodiode, and capturing the modulated reflected light.

Other features and advantages of the embodiments of the high speed optical system disclosed herein will become apparent from a consideration of the following detailed description.

### BRIEF DESCRIPTION OF THE DRAWINGS

A high speed optical system for changing image wavelength will be explained in more detail by way of the accompanying drawings, wherein:

FIG. 1 shows a cross sectional view of an embodiment of an avalanche photodiode as viewed along lines 1-1 of FIG. 2;

FIG. 2 shows a schematic diagram of an embodiment of an optical system having a first photon source emitting a first wavelength and a second photon source emitting a second wavelength to a photodiode;

FIG. 3 shows a schematic diagram of the embodiment of the optical system shown in FIG. 2 wherein the first photon source is transmitting an optical signal at the first wavelength to the photodiode;

FIG. 4 shows a cross sectional view of an embodiment of a avalanche photodiode as viewed along lines 4-4 of FIG. 3 having a first wavelength and a second wavelength incident thereon; and

FIG. 5 shows a schematic diagram of the embodiment of the optical system shown in FIG. 2 wherein light at the second wavelength having an optical signal thereon is reflected from the photodiode to a capture device.

### DETAILED DESCRIPTION

Photodiodes are electronic components having a P—N junction designed to be responsive to an optical input. As such, photodiodes are commonly used as photodetectors to detect the presence of photons within an area. Typically, photodiodes can be used in either zero bias or reverse bias. When used in zero bias, light falling on the photodiode causes a voltage to develop across the device, leading to a current in the forward bias direction, thereby resulting in the generation of a photovoltaic effect. In contrast, when a P—N junction photodiode is reverse biased, an electric field exists in the vicinity of the junction that keeps electrons confined to the N side and holes confinement to the P side of the junction. As a result, when an incident photon of sufficient energy (e.g. greater than 1.1 eV in the case of silicon) is absorbed in the region where the field exists, an electron—hole is generated. Under the influence of the electric field, the electron drifts to the N side and the hole drifts to the P side, resulting in the flow of a photocurrent in an external circuit coupled thereto.

Avalanche photodiodes (APD) detect light using the same principle. However, unlike ordinary P—N junction photodiodes, APD are designed to support high electric fields. As a result, when operated in normal avalanche mode, the electron-hole pair generated by photoabsorption permits a freed electron to accelerate and gain sufficient energy from the surrounding electrical field to collide with the crystal lattice of the material forming the APD and generate additional electron-hole pairs. Therefore, one photon incident upon the APD can result in the generation of a chain reaction of freeing electrons within the material forming the APD.

In addition to normal operational modes, APDs may be operated in Geiger mode. When operating in Geiger mode, a voltage greater than a breakdown voltage is applied to an APD. As a result, the incidence of a photon on the APD when operating in Geiger mode causes the chain reaction of freeing electrons in a photodiode material which continues until the current within an electrical field applied to the APD drops to zero or until the voltage falls below the breakdown voltage.

Further, the refractive index of photodiode materials is effected by several factors. For example, the refractive index of the photodiode material may be changed by the distribution of an electric charge in the material. This change in the refractive index of photodiode materials in response to the application of an electric charge thereto is termed the photorefractive effect and varies between materials. In addition, the refractive index may be altered when heat is applied thereto. When a portion of the photodiode material is heated, the material expands thereby changing the refractive index of the heated material. As such, when a photon strikes an APD, the electron freed within the photodiode material released as a result of the incident photon moves in an electric field and gives off heat while redistributing charge. The heat generated by the electron movement changes the refractive index of the photodiode material in the immediate area of the electron for a short duration of time, on the order of about 20 nanoseconds, until the heat dissipates. The redistribution of charge and the change in the refractive index persists for up to about 500 nanoseconds.

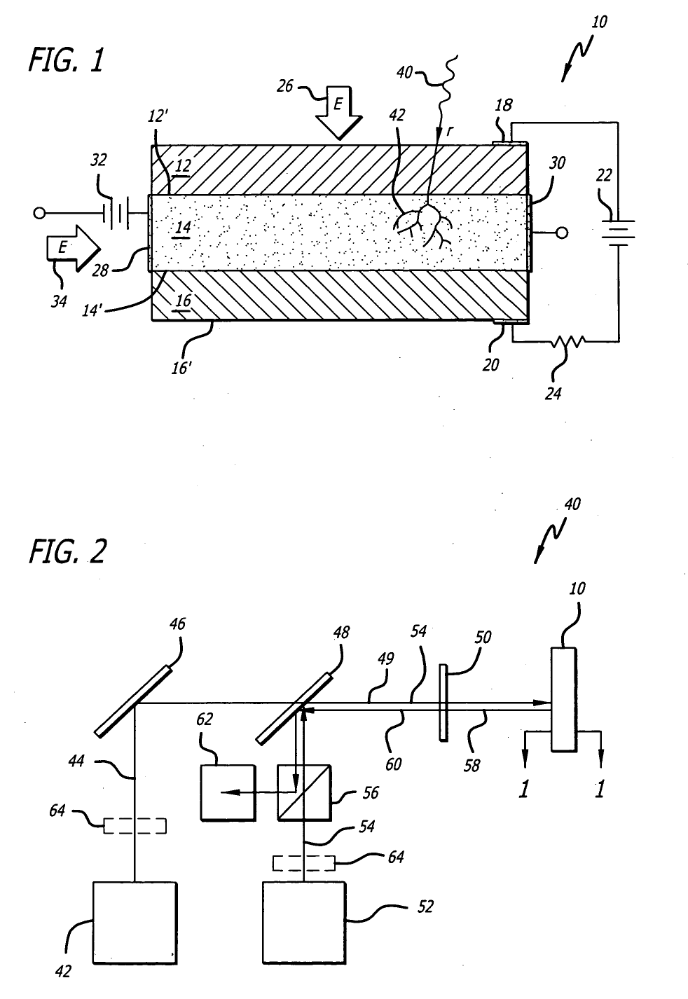

FIG. 1 shows a cross section of a three layer APD. As shown in FIG. 1, the APD 10 includes a first layer 12, a second layer 14, and a third layer 16. In one embodiment, the first layer 12 comprises a positively doped semiconductive material configured to permit an avalanche of electrons to be freed when struck with a photon. For example, in one embodiment the positively doped semiconductive material comprises silicon. In an alternate embodiment, the first layer 12 is comprised of indium phosphide and is heavily doped with a P-type material such as zinc. As a result, the first layer 12 loses its semiconductive properties and functions similar to a conductor. The second layer is either a negative layer or an insulator. For example, the second layer 14 maybe manufactured without doping or with low doping. The third layer 16 is a negative layer. In one embodiment, the third layer is moderately doped with an N-type material. In another embodiment, the third layer 16 is heavily doped with an N-type material such as sulfur, for example, such that the third layer 16 no longer behaves as a semiconductor but instead has a reasonable good conductivity. Optionally, the first, second, and/or third layers 12, 14, 16, respectively, may include at least one surface 12′, 14′, 16, respectively, which may be partially reflective to light of a selective wavelength.

Referring again to FIG. 1, the APD 10 may also include a first set of electrodes 18, 20 connected to a voltage source 22 and configured to apply a charge across the APD 10. Optionally, a circuit resistor 24 may be positioned between the voltage source 22 and at least one of the electrodes, 18, 20. As a result, a first electric field 26 may be created across the APD 10 and configured to permit the APD 10 to be operated in Geiger mode. Optionally, the APD 10 may also include a second set of electrodes 28, 30 coupled to a second voltage source 32. As such, a second electric field 34 may be created within or surrounding the APD 10. In the illustrated embodiment, the second electric field 34 is perpendicular to the first electric field 26. Optionally, any number of electric fields or field directions may be used. Furthermore, the APD 10 may be manufactured in any number of sizes or shapes as desired. For example, in one embodiment, the APD 10 may be configured to form an asymmetric Fabry-Perot etalon.

FIG. 2 shows a schematic diagram of a high speed optical system. As shown in FIG. 2, the optical system 40 includes a first light source 42 configured to emit a first wavelength of light 44. In one embodiment, the first light source 42 is configured to emit a first wavelength of light 44 having a wavelength shorter than the bandgap of the APD 10. For example, in one embodiment the first wavelength of light 44 is less than 1.59 microns. As a result, the first wavelength of light 44 will be absorbed by the APD 10, and may thus be considered an input to the APD 10. The first wavelength of light 44 is incident upon a beam director 46 which directs the light through a beam combiner 48 to the APD 10. As shown in FIG. 2, at least one optical filter 50 may be positioned within the optical path. In the illustrated embodiment, a

$$\frac{λ}{4}$$

plate 50 is positioned within the optical path between the beam combiner 48 and the APD 10. Optionally, any number or variety of optical filters 50 may be used with the optical system 40.

The APD 10 may be manufactured from any variety of material, including, without limitation, Indium Gallium Arsenide (InGaAs), Indium Gallium Arsenide Phosphide (InGaAsP), Silicon (Si), Germanium (Ge), Gallium Nitride (GaN), Silicon Carbide (SiC), or any other suitable materials, In addition, the APD 10 may be manufactured in any number of sizes or shapes as desired. For example, in one embodiment, the APD 10 may be configured to form an asymmetric Fabry-Perot etalon. Optionally, the APD 10 may comprise a photodiode array having multiple photodiodes positioned proximate to each other.

Referring again to FIG. 2, the optical system 40 further includes a second light source 52 configured to emit a second wavelength of light 54 to the APD 10. In one embodiment, a second wavelength of light 54 has a wavelength longer than the bandgap of the APD 10. As such, the second wavelength of light 54 will not be absorbed by the APD 10. The second wavelength of light 54 is incident upon and traverses through a beam splitter 56. Optionally, the beam splitter 56 may comprise a polarizing beam splitter. Thereafter, the second wavelength of light 54 is incident upon the beam combiner 48 and is combined with the first wavelength of light 44 emitted by the first light source 42. The second wavelength of light 54, which is combined with the first wavelength of light 44, is directed through the

$$\frac{λ}{4}$$

plate 50 and is incident upon the APD 10.

As shown in FIG. 2, the first wavelength of light 44 and the second wavelength of light 54 are incident upon APD 10. Reflected light 58 is reflected off a surface of the APD 10 and is incident upon the

$$\frac{λ}{4}$$

plate 50 positioned within the optical path, which modulates the reflected light 58. As such, the reflected light 58 may be considered an output of the APD 10. The modulated reflected light 60 is incident upon the beam combiner 48 which directs the modulated reflected light 60 into a capture device 62 in optical communication with the beam splitter 56. Exemplary capture devices 62 include, without limitation, cameras, CCD devices, imaging arrays, photometers, and like devices. The reflected light 58 and modulated light 60 comprises the second wavelength of light 44, which is greater than the bandgap of the APD 10. As such, the reflected light 58 and modulated light 60 are not be absorbed by the APD 10. Optionally, additional optical components 64 may be positioned anywhere within the optical system 40. For example, additional optical component 64 may be positioned proximate to the first light source 42. In an alternate embodiment, additional optical components 64 are positioned approximate to the second light source 52. Exemplary additional optical components 64 include, without limitation, wavelength filters, spatial filters, shutters, light modulators, light valves, lens, objectives, or the like.

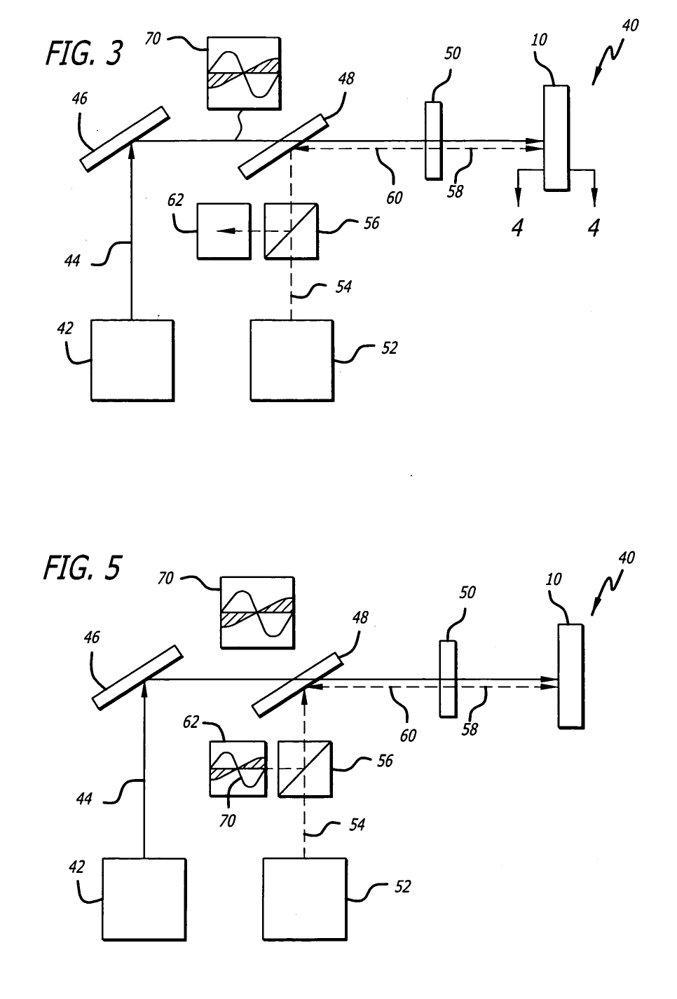

FIGS. 3-5 show an embodiment of the optical system 40 during use. As shown in FIG. 3, the first wavelength of light 44 emitted by the first light source 42 contains an image or signal 70 which is directed to the APD 10 by the beam director 46. In addition, the APD 10 is simultaneously irradiated with the second wavelength of light 54 emitted by the second light source 52. The first wavelength of light 44 containing the signal 70 and a second wavelength of light 54 are combined by the beam combinder 48 and are directed through the

$$\frac{λ}{4}$$

plate 50 to the APD 10. As described above, the APD 10 is configured to operate in Geiger mode. The first wavelength of light 44 causes localized pixel heating due to absorption within the photodiode materials, thereby inducing modulation of the refractive index of the photodiode material.

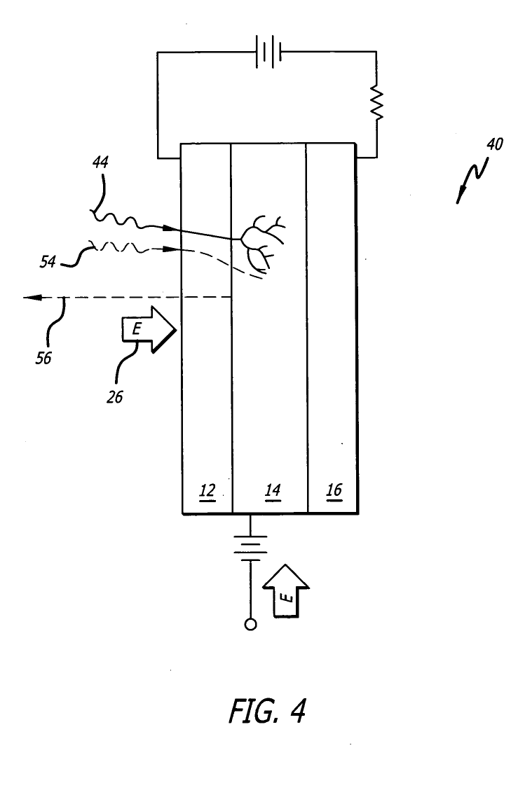

As shown in FIG. 4, the APD 10 may be configured to approximate an asymmetric Fabry-Perot etalon. Like the modulation of refractive index described above, the reflectivity of the APD 10 is modulated at a point where the photon of the first wavelength of light 44 is incident upon the APD 10. The index of refraction and reflectivity of the photodiode materials is modulated in the same pattern as the image or signal 70 from the first wavelength of light 44. As such, the light 58 reflected from the APD 10, at the second wavelength which is greater than the bandgap of the APD 10, is modulated to reproduced the image or signal 70.

As shown in FIG. 5, the reflected light 58 carrying the signal 70 is incident upon the

$$\frac{λ}{4}$$

plate 50 which permits light of a selected polarization to traverse therethrough and which is captured by the capture device 62 coupled to the beam splitter 56. The capture device 62 captures the image signal 70 at the second wavelength 54. As such, the reflected light 60 at the second wavelength received at the capture device 62 is modulated to include the image or signal 70 and has the same intensity pattern as the first wavelength 44. However, unlike prior art systems, the high speed optical system 40 disclosed herein converts the wavelength of the image in an optical-to-optical conversion process considerably faster the present systems while reducing or eliminating noise in the system. For example, the high speed optical system disclosed herein may be configured to convert an input optical signal at a first wavelength to an output optical signal at a second wavelength in time ranges on the order of 1 nanosecond.

Embodiments disclosed herein are illustrative of the principles of the invention. Other modifications may be employed which are within the scope of the invention, thus, by way of example but not of limitation, alternative photodiode configurations, alternative beam director devices, alternative optical filters, and alternative electronic components. Accordingly, the devices disclosed in the present application are not limited to that precisely as shown and described herein.

1. A device, comprising:
a photodiode which is sensitive to a wavelength of light;
a first source of photons at a first wavelength to which the photodiode is sensitive incident on the photodiode;
a second source of photons at a second wavelength to which the photodiode is insensitive incident on the photodiode;
an electric field across the photodiode in excess of a breakdown voltage thereof and configured to result in an avalanching of electrons in the photodiode when the photons from the first source strike the photodiode, the avalanching electrons resulting in a photorefractive response which changes the index of refraction in the photodiode; and
a capture device in optical communication with and configured to capture light reflected from the photodiode.

2. The device of claim 1 wherein the first source of photons transmits an optical signal to the photodiode.

3. The device of claim 1 wherein the first wavelength is less than the bandgap of the photodiode.

4. The device of claim 1 wherein the second wavelength is greater than the bandgap of the photodiode.

5. The device of claim 1 wherein the light reflected from the photodiode is modulated by the photoreactive response of the photodiode.

6. The device of claim 1 further comprising a beam combiner configured to combine the first and second wavelengths, the beam combiner positioned between the photon sources and the photodiode.

7. The device of claim 1 further comprising at least one optical filter positioned between the photon sources and the photodiode.

8. The device of claim 7 wherein the optical filter comprises a λ/4 plate.

9. The device of claim 1 wherein the capture device comprises at least one device selected from the group consisting of cameras, CCD devices, imaging arrays, and photometers.

10. The device of claim 1 further comprising at least one optical component positioned between at least one of the photon sources and the photodiode.

11. The device of claim 10 wherein the at least one optical component is selected from the group consisting of wavelength filters, spatial filters, shutters, light modulators, light valves, lens, lens systems, and objectives.

12. The system of claim 1 wherein the photodiode further comprises an InGaAsP photodiode.

13. The device of claim 1 wherein the photodiode is configured to operate in Geiger mode.

14. A device, comprising:
an InGaAsP photodiode which is sensitive to a wavelength of light;
a first source of photons configured to transmit an optical signal at a first wavelength to which the photodiode is sensitive incident to the photodiode;
a second source of photons at a second wavelength to which the photodiode is insensitive incident on the photodiode; p1 an electric field across the photodiode in excess of a breakdown voltage thereof and configured to result in an avalanching of electrons in the photodiode when the photons from the first source strike the photodiode, the avalanching electrons resulting in a photorefractive response which changes the index of refraction in the photodiode; and
a capture device in optical communication with and configured to capture light reflected from the photodiode.

15. The device of claim 14 wherein the first wavelength is less than the bandgap of the photodiode.

16. The device of claim 14 wherein the second wavelength is greater than the bandgap of the photodiode.

17. The device of claim 14 wherein the light reflected from the photodiode is modulated by the photoreactive response of the photodiode.

18. The device of claim 14 further comprising a beam combiner positioned between the light sources and the photodiode.

19. The device of claim 14 further comprising a polarizing plate positioned between the light sources and the photodiode.

20. The device of claim 14 wherein the capture device comprises a camera.

21. The device of claim 14 wherein the photodiode is configured to operate in Geiger mode.

22. A system, comprising:
an InGaAsP photodiode having a bandgap, the photodiode configured to operate in Geiger mode;
a first photon source configured to emit an optical signal of a first wavelength, the first wavelength less than the bandgap of the photodiode;
a second photon source configured to emit light of a second wavelength, the second wavelength greater than the bandgap of the photodiode;
a beam combiner positioned within an optical path and configured to combine the first and second wavelengths;
an electric field applied across the photodiode greater than a breakdown voltage thereof, the electric field configured to result in avalanching of electrons in the photodiode when photons from a first photodiode are incident thereon, the avalanche of electrons resulting in a photorefractive response within the photodiode; and
a capture device in optical communication with and configured to capture modulated light reflected from the photodiode.

23. A method, comprising:
baising a photodiode to operate in Geiger mode;
irradiating a photodiode with a first wavelength of light to which the photodiode is sensitive, the first wavelength of light transmitting an optical signal;
irradiating the photodiode with a second wavelength of light to which the photodiode is insensitive;
modulating light reflected from a surface of the photodiode with a photorefractive reaction within the photodiode; and
capturing the modulated reflected light.

24. The method of claim 23 further comprising filtering the modulated reflected light prior to capture.

25. A method comprising
configuring a photodiode to operate in Geiger mode;
irradiating a photodiode with the first wavelength of light transmitting an optical signal;
initiating a photorefractive reaction within the photodiode with a first wavelength of light;
irradiating the photodiode with a second wavelength of light to which the photodiode is insensitive;
modulating light reflected from a surface of the photodiode with the photorefractive reaction within the photodiode; and
capturing the modulated reflected light.
